(19) United States
(12) Patent Application Publication
(10) Pub. No.: US 2024/0356100 A1
(43) Pub. Date: Oct. 24, 2024

(54) BATTERY INSULATION SHEET, MANUFACTURING METHOD THEREOF, AND BATTERY MODULE COMPRISING THE SAME

(71) Applicant: Samsung SDI Co., Ltd, Yongin-si (KR)

(72) Inventors: Hye Jin PARK, Yongin-si (KR); Myung Heui WOO, Yongin-si (KR); Bo Kyung RYU, Yongin-si (KR); Seung Yong YANG, Yongin-si (KR); Jae Hyun LEE, Yongin-si (KR); Ha Na RA, Yongin-si (KR); Jung Hyo LEE, Yongin-si (KR); Hyun NAM, Yongin-si (KR); Jung Hyun NAM, Yongin-si (KR); Yun Sung YANG, Yongin-si (KR)

(21) Appl. No.: 18/639,755

(22) Filed: Apr. 18, 2024

(30) Foreign Application Priority Data
Apr. 21, 2023 (KR) 10-2023-0052566
Aug. 14, 2023 (KR) 10-2023-0106093

(51) Int. Cl. H01M 10/653; H01M 50/204

(52) U.S. Cl. CPC H01M 10/653; H01M 50/204

(57) ABSTRACT

A battery insulation sheet including an aerogel layer. The aerogel layer includes: a fibrillized polymer matrix comprising a dry binder; and aerogel particles distributed in the fibrillized polymer matrix.

### CROSS-REFERENCE TO THE RELATED APPLICATIONS

The present application claims priority to and the benefit of Korean Patent Application Nos. 10-2023-0052566 and 10-2023-0106093, filed on filed on Apr. 21, 2023 and Aug. 14, 2023, respectively, in the Korean Intellectual Property Office, the entire disclosure of each of which is incorporated herein by reference.

### BACKGROUND

### 1. Field

Aspects of embodiments of the present disclosure relate to a battery insulation sheet, a method of manufacturing the same, and a battery module including the same.

### 2. Description of the Related Art

A secondary battery is a power storage system that converts electrical energy into chemical energy, stores the chemical energy, and provides high energy density. Compared to a primary battery, which is not designed to be rechargeable, a secondary battery is designed to be rechargeable and is widely used in IT devices, such as smartphones, cellular phones, laptop computers, and tablet computers. Recently, there has been increased interest in electric vehicles as a way to reduce or prevent environmental pollution, and high-capacity secondary batteries are being adopted for use in electric vehicles. The secondary battery typically exhibits characteristics, such as high density, high output, and good stability.

If a plurality of high-capacity cells is included in a battery module, such as in a lithium secondary battery, one cell may overheat and may go into thermal runaway for various reasons, which may adversely affect other cells adjacent thereto. Therefore, it is desirable to thermally isolate neighboring cells from each other.

Conventionally, in some cases, a plate or an insulating resin sheet is disposed between cells to isolate and insulate the neighboring cells from each other.

The information disclosed in this section is provided for enhancement of understanding of the background of the present disclosure, and therefore, it may contain information that is not related (or prior) art.

### SUMMARY

Embodiments of the present disclosure provide a battery insulation sheet having desirable thermal insulation, heat resistance, low dust properties, and flexibility, a method of manufacturing the same, and a battery module including the same.

According to an embodiment of the present disclose, a battery insulation device includes: an aerogel layer, the aerogel layer including: a fibrillized polymer matrix including a dry binder; and aerogel particles distributed in the fibrillized polymer matrix.

The dry binder may include a fluorinated binder, wherein the fluorinated binder is at least one selected from a group consisting of polytetrafluoroethylene, a polyvinylidene fluoride-hexapropylene copolymer, or polyvinylidene fluoride.

The fibrillated polymer matrix may account for 10 wt % to 90 wt % of a total amount of the aerogel layer, and the aerogel particles may account for 10 wt % to 90 wt % of the total amount of the aerogel layer.

The aerogel particles may have a BET specific surface area in a range of 500 m²/g to 1,000 m²/g.

The aerogel particles may have an average particle size (D50) in a range of 5 μm to 100 μm.

The aerogel particles may be dispersed in the fibrillized polymer matrix.

The aerogel layer may satisfy Formula 1 below:

$$0.1 \leq {W}_{FB} / {T}_{PM} \leq 18 \qquad [ Formula 1 ]$$

wherein W_{FB} is the content (in wt %) of the dry binder to the total amount of the aerogel layer, and T_{PM} is the average particle size (in μm) of the aerogel particles.

The battery insulation sheet may further include a substrate on an upper surface, a lower surface, or upper and lower surfaces of the aerogel layer.

The battery insulation sheet may have a structure in which a first substrate, the aerogel layer, and a second substrate are sequentially laminated.

According to an embodiment of the present disclosure, a method of manufacturing a battery insulation sheet includes: manufacturing a raw material mixture including a powdered dry binder and powdered aerogel particles; and extruding the raw material mixture by using an extruder to manufacture an aerogel layer, wherein the aerogel layer includes a fibrillized polymer matrix including the dry binder in which aerogel particles are distributed.

The manufacturing of the raw material mixture may include a primary dry mixing step or primary and secondary dry mixing steps.

The manufacturing of the raw material mixture may include a primary dry mixing step and a secondary dry mixing step, and a stirring speed in the secondary dry mixing step may be at least 2 times a stirring speed in the primary dry mixing step.

In the primary dry mixing step, a temperature may be in a range of 20° C. to 65° C., a stirring speed may be 2000 rpm or less, and a stirring time may be in a range of 5 min to 15 min. In the secondary dry mixing step, a temperature may be in a range of 20° C. to 65° C., a stirring speed may be in a range of 4000 rpm to 10,000 rpm, and a stirring time may be in a range of 10 min to 60 min.

The manufacturing of the aerogel layer may include introducing the raw material mixture into the extruder and extruding the raw material mixture in a sheet form.

The manufacturing of the aerogel layer may be performed at a temperature in a range of 25° C. to 150° C. and a pressure in a range of 1 MPa to 100 MPa.

The method of manufacturing a battery insulation sheet may further include laminating a substrate on an upper surface, a lower surface, or upper and lower surfaces of the aerogel layer.

A first substrate and a second substrate may be laminated on upper and lower surfaces of the aerogel layer, respectively.

According to an embodiment of the present disclose, a battery module includes: a plurality of cells; and the battery insulation sheet as described previously between the plurality of cells. Upper and lower surfaces of the battery insulation sheet respectively face adjacent ones of the cells.

### BRIEF DESCRIPTION OF DRAWINGS

The accompanying drawings, which are incorporated in this specification, illustrate embodiments of the present disclosure and are provided to further illustrate aspects and features of the present disclosure in conjunction with the detailed description that follows. The disclosure is not to be construed as limited to what is shown in such drawings. In the drawings:

FIG. 1 is a schematic view showing the structure of a battery insulation sheet according to embodiments;

FIG. 2 is a schematic view showing the structure of a battery insulation sheet according to other embodiments;

FIG. 3 is a schematic view showing the structure of a battery insulation sheet according to other embodiments;

FIG. 4 is a schematic view showing a battery insulation sheet between a plurality of cells according to embodiments.

### DETAILED DESCRIPTION

Hereinafter, embodiments of the present disclosure will be described, in detail, such that a person having ordinary skill in the art can easily implement the embodiments. However, the present disclosure, and the described embodiments, may be implemented in many different forms and are not limited to the embodiments described herein.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

An insulating material, which is a material that prevents or reduces heat from flowing from higher to lower temperature areas, is used not only in refrigerators, cold storages, and buildings but also in a variety of other industries, including the aircraft, electronics, and automotive industries.

The insulating material provides desirable thermal insulation performance through low thermal conductivity and mechanical strength to maintain thermal insulation performance over time.

Aerogel, which is an advanced transparent or translucent material having a nanoporous structure, exhibits very low density and low thermal conductivity. Therefore, aerogel has received attention as an insulating material and is considered to be a highly-efficient super-insulating material that can be used in a variety of industrial applications.

Some aspects of aerogel are that aerogel has lower thermal conductivity than conventional organic insulating materials, such as closed-cell foams, such as Styrofoam® (a registered trademark owned by DDP SPECIALTY ELECTRONIC MATERIALS US, INC.), and that aerogel avoids weaknesses of organic insulating materials, such as fire vulnerability and generation of harmful gases in the event of fire.

A battery insulation sheet according to embodiments may include an aerogel layer including a fibrillized polymer matrix and aerogel particles distributed in the fibrillized polymer matrix. In some embodiments, the fibrillized polymer matrix may include a dry binder.

The battery insulation sheet having the above structure may include a relatively high content of the dry binder, which exhibits heat resistance to improve heat resistance as well as thermal insulation. The dry binder may be present in a fibrillized polymer matrix structure, and the aerogel particles may be dispersed in the fibrillized polymer matrix such that the battery insulation sheet may have desirable flexibility and detachment of the aerogel particles (also referred to as dusting) may be mitigated or prevented so that the battery insulation sheet may have low dust properties.

The dry binder may have desirable heat resistance but may be relatively difficult to disperse in water. However, the battery insulation sheet according to embodiments may include a relatively high content of the dry binder without affecting dispersibility of the dry binder through a dry process such that the dry binder can be easily included in the insulation sheet, thereby providing improved heat resistance, desired heat resistance may be achieved through a relatively thin thickness of the insulation sheet, and detachment of aerogel particles may be reduced.

In embodiments, the fibrillized polymer matrix may include no (or may omit any) aqueous binder. An aqueous binder may refer to an ordinary water-soluble binder and may include, for example, an inorganic binder, an aqueous polymer, an anionic water-soluble polymer, a cationic water-soluble polymer, and/or a water-dispersible polymer.

The fibrillized polymer matrix may be manufactured through a dry process and may include no aqueous binder. Because no aqueous binder is included, an aerogel layer with a dispersed structure of aerogel in the fibrillized polymer matrix may be formed by extrusion in a dry process (e.g., a dry extrusion process).

The inorganic binder may include soluble silicate and may be an ordinary aqueous polymer, such as sodium silicate, potassium silicate, or lithium silicate.

The aqueous polymer may refer to an ordinary aqueous polymer, such as polyvinyl alcohol, polyethylene oxide, polyacrylamide, or polyvinylpyrrolidone.

The anionic water-soluble polymer may refer to an ordinary anionic water-soluble polymer, such as a polymer having functional groups of carboxylic acid, sulfonic acid, sulfuric acid ester, and/or phosphoric acid ester, or a polymer having functional groups of salts thereof.

The cationic water-soluble polymer may refer to at least one selected from the group consisting of amine, ammonium, phosphonium, sulfonium, and/or a polymer having functional groups of salts thereof. For example, the cationic water-soluble polymer may be a polymer having an amine group, and the cationic water-soluble polymer may be an ordinary cationic water-soluble polymer, such as polyethylene amine or polyamine.

The water-dispersible polymer may refer to an ordinary water-dispersible polymer, such as water-dispersible polyurethane or water-dispersible polyester.

The dry binder may be, for example, a fibrillized binder. The dry binder may be a binder capable of being fibrillated or a binder fibrillated so as to form a matrix.

The dry binder may be a binder that is not impregnated, soluble, and/or dispersible in a solvent. The dry binder may be a fibrillated binder, which may act as a matrix configured to support and bind aerogel (e.g., aerogel particles). The dry binder may have an aspect ratio of about 10 or more, about 20 or more, about 50 or more, or about 100 or more.

The dry binder may include at least one copolymer selected from the group consisting of polytetrafluoroethylene (PTFE), a polyvinylidene fluoride-hexapropylene (PVDF-HFP) copolymer, polyvinylidene fluoride (PVDF), polyacrylonitrile, carboxymethylcellulose (CMC), starch, hydroxypropylcellulose, cellulose, polyvinylpyrrolidone, polyethylene, polypropylene, ethylene-propylene-diene polymer (EPDM), sulfonated-EPDM, styrene butadiene rubber (SBR), and/or fluorinated rubber; however, embodiments of the present disclosure are not limited thereto.

For example, the dry binder may include a fluorinated binder. The fluorinated binder may include at least one selected from the group consisting of polytetrafluoroethylene (PTFE), a polyvinylidene fluoride-hexapropylene (PVDF-HFP) copolymer, and/or polyvinylidene fluoride (PVDF). Because the dry binder is included, the binder may be fibrillated through a dry process. In the dry process, a raw material mixture may be extruded by using an extruder to manufacture an aerogel layer. If an aqueous binder is included, it may be difficult to fibrillate the binder.

In embodiments, the aerogel particles may have a BET specific surface area in a range of about 500 m²/g to about 1,000 m²/g. For example, the aerogel particles may have a BET specific surface area in a range of about 500 m²/g to about 950 m²/g, about 550 m²/g to about 950 m²/g, or about 600 m²/g to about 900 m²/g. When the aerogel particles having the BET specific surface area value within the above ranges are included, heat transfer and heat propagation between a plurality of cells may be effectively prevented, thereby improving thermal insulation of the battery insulation sheet.

The average particle size D50 of the aerogel particles may be in a range of about 5 μm to about 100 μm, about 10 μm to about 100 μm, or about 50 μm to about 100 μm. When the aerogel particles having the particle size within the above ranges are included, thermal insulation may be improved while substantially preventing agglomeration between the aerogel particles and an increase in the thickness of the insulation sheet to further delay heat transfer between the plurality of cells.

The average particle size D50 may be measured, for example, by using a laser diffraction method or scanning electron microscopy (SEM). The average particle size D50 of particles may be defined as the particle size at 50% of the particle size distribution (e.g., the particle size corresponding to cumulative 50% of the volume of the particle size distribution).

The aerogel particles may be dispersed in the fibrillated polymer matrix. When an aerogel layer is formed by using a manufacturing method described below, the aerogel layer may be formed to have a structure in which aerogel particles are uniformly or substantially uniformly dispersed in the fibrillated polymer matrix.

In embodiments, the fibrillated polymer matrix may be included in an amount to account for about 10 wt % to about 90 wt % of the total amount of the aerogel layer, and the aerogel particles may be included in an amount to account for about 10 wt % to about 90 wt % of the total amount of the aerogel layer.

The fibrillated polymer matrix may be included in an amount to account for about 20 wt % to about 90 wt %, about 20 wt % to about 75 wt %, or about 20 wt % to about 65 wt % of the total amount of the aerogel layer, and the aerogel particles may be included in an amount to account for about 10 wt % to about 80 wt %, about 25 wt % to about 80 wt %, or about 35 wt % to about 80 wt % of the total amount of the aerogel layer. By varying the content of the fibrillated polymer matrix and the aerogel particles in the aerogel layer within the above range, a battery insulation sheet having desirable thermal insulation, heat resistance, flexibility, and low dust properties may be provided.

In embodiments, the content of the dry binder may be adjusted depending on the size of the aerogel particles. The aerogel layer may satisfy Formula 1 below.

$$0.1 \leq {W}_{FB} / {T}_{PM} \leq 18 \qquad Formula 1$$

In Formula 1 above, W_{FB} indicates the content (wt %) of the dry binder with respect to the total amount of the aerogel layer, and T_{PM} indicates the average particle size (μm) of the aerogel particles.

The W_{FB}/T_{PM} value may in a range of about 0.1 to about 18, about 0.1 to about 10, about 0.1 to about 5, or about 0.2 to about 1.3. The W_{FB}/T_{PM} value may indicate the relationship between the average particle size of the aerogel particles and the content of the dry binder that can be included in the aerogel layer. For example, as the size of the aerogel particles increases, it may be more difficult for the dry binder to be packed into the fibrillated matrix, and as the size of the aerogel particles decreases, the specific surface area may increase, requiring an excessive amount of the binder, which may reduce the thermal insulation of the insulation sheet. Therefore, the aerogel particle size may affect the content of the dry binder that can be included. By adjusting the W_{FB}/T_{PM} value to be within the above range, therefore, it is possible to provide a battery insulation sheet having desirable thermal insulation, heat resistance, flexibility, and low dust properties with a small thickness.

The aerogel layer may have a structure in which the aerogel particles are uniformly distributed in the fibrillated polymer matrix by using a manufacturing method, a description of which will follow. The aerogel layer may have desirable thermal insulation even if the aerogel layer is formed to have a small thickness because there are not many empty spaces therein. The aerogel layer may have desirable heat resistance because the aerogel layer may include a high content of the dry binder having heat resistance. Because the aerogel particles may be substantially uniformly distributed in the fibrillated polymer matrix, dust generation due to detachment of the aerogel particles may be reduced or prevented. Internal voids of the aerogel layer may absorb vibration and shock but may increase the thickness of the insulation sheet.

The battery insulation sheet according to embodiments may be used as an insulation sheet for various types of batteries because the aerogel layer may achieve desirable flexibility through the fibrillated polymer matrix even though the aerogel layer does not have many internal voids, and in an environment where the battery is not stationary during operation but is in motion, such as in an electric vehicle, detachment of the aerogel particles may be prevented.

The thickness of the aerogel layer may be in a range of about 1 mm to about 10 mm, about 1 mm to about 5 mm, or about 1 mm to about 3 mm. By forming the aerogel layer on a substrate having a thickness within the above range, an insulation sheet having desirable thermal insulation, heat resistance, flexibility, and low dust properties with a small thickness may be manufactured.

In embodiments, the battery insulation sheet may further include a substrate provided on an upper surface, a lower surface, or upper and lower surfaces of the aerogel layer.

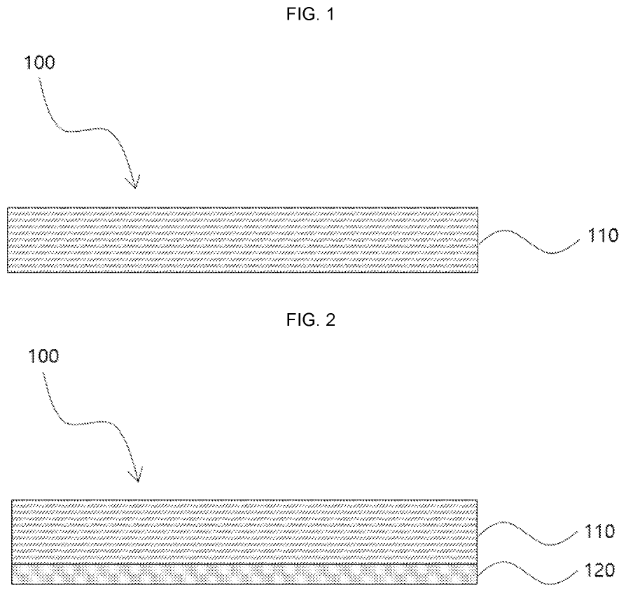

As an example, FIG. 1 is a schematic view showing the structure of a battery insulation sheet according to an embodiment.

Referring to FIG. 1, the battery insulation sheet 100 may include an aerogel layer 110. An upper surface and a lower surface of the aerogel layer 110 may be disposed to face cells (e.g., battery cells) adjacent thereto, respectively.

As another example, FIG. 2 is a schematic view showing the structure of a battery insulation sheet according to another embodiment.

Referring to FIG. 2, the battery insulation sheet 100 includes a substrate 120 and an aerogel layer 110 formed on the substrate 120. An upper surface of the battery insulation sheet (e.g., an upper surface of the aerogel layer 110) and a lower surface of the substrate 120 may be disposed to face cells adjacent thereto, respectively.

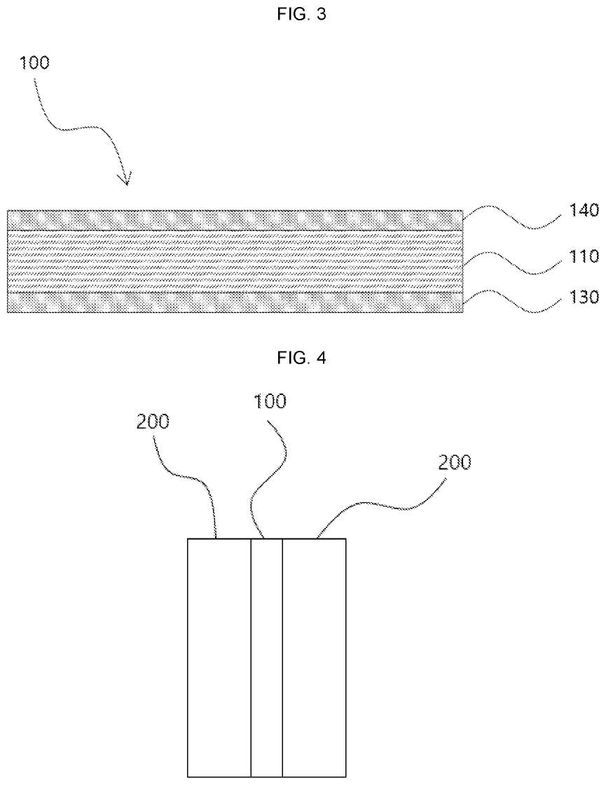

As a further example, FIG. 3 is a schematic view showing the structure of a battery insulation sheet according to another embodiment.

Referring to FIG. 3, the battery insulation sheet 100 may have a structure including a first substrate 130, an aerogel layer 110 formed on the first substrate 130, and a second substrate 140 on (e.g., formed on) the aerogel layer 110. The battery insulation sheet may have a structure in which the first substrate 130, the aerogel layer 110, and the second substrate 140 are sequentially laminated. The first substrate 130 and the second substrate 140 may be disposed to face cells adjacent thereto, respectively. The first substrate 130 and the second substrate 140 may be made of the same material or different materials.

The substrate (e.g., the first substrate 130, the second substrate 140, or the substrate 120 described above) may include, without being limited to, a resin, a metal, an inorganic material other than the metal, and/or a composite thereof. The form of the substrate may be, without being limited to, a film, a membrane, a sheet, etc. The substrate may refer to the substrate 120 shown in FIG. 2 or the first substrate 130 and the second substrate 140 shown in FIG. 3.

The resin may include at least one selected from the group consisting of, for example, polyethylene, polypropylene, polystyrene, polyethylene terephthalate, and/or polyamide.

The metal may include at least one selected from the group consisting of, for example, copper, nickel, cobalt, iron, chromium, vanadium, palladium, ruthenium, rhodium, molybdenum, tungsten, iridium, silver, gold, and/or platinum. When a substrate made of the above metal is used, the substrate may be subjected to anti-corrosion treatment or insulating treatment.

The inorganic material may include at least one selected from the group consisting of calcium carbonate (CaCO₃), talc, and/or mica.

In one embodiment, the substrate may include an inorganic material, more specifically, the substrate may include mica. In such an embodiment, thermal insulation, durability, etc. of the insulation sheet may be improved.

The thickness of the substrate may be in a range of about 0.01 mm to about 5 mm, about 0.05 mm to about 3 mm, or about 0.1 mm to about 1 mm. When a substrate having a thickness within the above range is included, durability of the battery insulation sheet may be improved.

A method of manufacturing a battery insulation sheet according to embodiments may include a step of manufacturing a raw material mixture including a powdered dry binder and powdered aerogel particles and a step of extruding the raw material mixture by using an extruder to manufacture an aerogel layer including a fibrillized polymer matrix in which aerogel particles are distributed and a dry binder.

The method of manufacturing the battery insulation sheet may be performed entirely through a dry process, and a detailed description the aerogel layer may be the same as described above.

In the step of manufacturing the raw material mixture including the powdered dry binder and the powdered aerogel particles, a detailed description of the dry binder and the aerogel particles may be the same as described above.

In the step of manufacturing the raw material mixture, the dry binder and the aerogel particles may contain no solvent and may be mixed in a powder phase.

The step of manufacturing the raw material mixture may be performed through one or two mixing steps. The step of manufacturing the raw material mixture may include a primary dry mixing step and a secondary dry mixing step. The stirring speed in the secondary dry mixing step may be at least about 2 times, in a range of about 2 to about 8 times, or in a range of about 4 to about 6 times the stirring speed in the primary dry mixing step.

In the primary dry mixing step, the temperature may be in a range of about 20° C. to about 65° C., about 25° C. to about 50° C., or about 25° C. to about 35° C., the stirring speed may be about 2000 rpm or less, in a range of about 500 rpm to about 1800 rpm, or in a range of about 800 rpm to about 1300 rpm, and the stirring time may be in a range of about 5 min to about 15 min.

In the secondary dry mixing step, the temperature may be in a range of about 20° C. to about 65° C., about 25° C. to about 50° C., or about 25° C. to about 35° C., the stirring speed may be in a range of about 4000 rpm to about 10,000 rpm, about 4000 rpm to about 8000 rpm, or about 4000 rpm to about 6000 rpm, and the stirring time may be in a range of about 10 min to about 60 min, about 10 min to about 40 min, or about 20 min to about 30 min.

The raw material mixture that has gone through the first and secondary dry mixing steps under the above conditions is extruded to form the aerogel layer having the aerogel particles distributed in the fibrillized polymer matrix.

In the step of manufacturing the raw material mixture, a stirrer may be used for stirring. The stirrer may include, for example, a kneader. For example, the stirrer may have a structure including a chamber, at least one rotating shaft rotatably disposed in the chamber, and a blade rotatably coupled to the rotating shaft. The blade may be disposed in a longitudinal direction of the rotating shaft. The blade may include at least one selected from among, for example, a ribbon blade, a sigma blade, a jet (Z) blade, a dispersing blade, and a screw blade. When the blade is included, the aerogel particles and the dry binder may be effectively mixed without any solvent to manufacture a dough-like raw material mixture.

In manufacturing the raw material mixture, the dry binder may be included in a range to account for about 20 wt % to about 70 wt %, about 30 wt % to 60 about wt %, or about 40 wt % to about 60 wt % of the total amount of the raw material mixture, and the aerogel particles may be included in a range to account for about 30 wt % to about 80 wt %, about 40 wt % to about 70 wt %, or about 40 wt % to about 60 wt % of the total amount of the raw material mixture. When the raw material mixture is manufactured within the above range, an aerogel layer having desirable thermal insulation, heat resistance, flexibility, and low dust properties may be manufactured.

In embodiments, the step of manufacturing the aerogel layer may include introducing the raw material mixture into the extruder and extruding the raw material mixture in the form of a sheet.

The step of manufacturing the aerogel layer may be performed at a temperature in a range of about 25° C. to about 150° C., about 30° C. to about 100° C., or about 30° C. to about 70° C. In the step of manufacturing the aerogel layer, the pressure during extrusion may be in a range of about 1 MPa to about 100 MPa, about 20 MPa to about 80 MPa, or about 30 MPa to about 70 MPa. When the raw material mixture is extruded under the above conditions, an aerogel layer having a structure in which the aerogel particles are uniformly distributed in the dry binder may be formed.

The method of manufacturing the battery insulation sheet according to an embodiment may be performed through a dry process in which no process solvent is included, and therefore, no additional process for removing a residual solvent may be needed.

In embodiments, when the raw material mixture is extruded through the extruder in the step of manufacturing the aerogel layer, the temperature may be in a range of about 20° C. to about 90° C., about 30° C. to about 60° C., or about 35° C. to about 55° C. The pressure during extrusion may be in a range of about 30 MPa to about 70 MPa, about 40 MPa to about 65 MPa, or about 40 MPa to about 60 MPa. When the raw material mixture is extruded under conditions within the above range, an aerogel layer including a fibrillized polymer matrix in which the aerogel particles are dispersed may be manufactured.

The extruder may be, but is not limited to, a known extruder. For example, a uniaxial extruder and a twin-screw extruder may be used.

In embodiments, the method may further include a step of laminating a substrate on an upper surface, a lower surface, or upper and lower surfaces of the aerogel layer. As an example, a battery insulation sheet may be manufactured by laminating the aerogel layer onto a substrate. In another example, a battery insulation sheet may be manufactured by laminating a first substrate and a second substrate on the upper and lower surfaces of the aerogel layer, respectively. The substrate, the first substrate, and the second substrate may be the same as described above.

In the step of laminating the substrate, the substrate may be laminated on the upper surface, the lower surface, or the upper and lower surfaces of the aerogel layer by using an adhesive. The step of laminating the substrate may be performed by forming an adhesive layer on the lower surface, or on the upper and lower surfaces, of the aerogel layer by coating of an ordinary adhesive and laminating the substrate on the adhesive layer.

A battery module according to embodiments may include a plurality of cells and the battery insulation sheet disposed between the plurality of cells. The upper and lower surfaces of the battery insulation sheet may be disposed to face cells adjacent thereto, respectively.

FIG. 4 is a schematic view showing a battery insulation sheet between the plurality of cells according to embodiments.

Referring to FIG. 4, the battery insulation sheet 100, according to an embodiment, may be formed (or placed) between a plurality of cells 200 included in a battery module. The battery insulation sheet 100 may have an upper surface, a lower surface, and a border side surface between the upper surface and the lower surface. The upper and lower surfaces of the battery insulation sheet 100 may be disposed (or arranged) to face cells 200 adjacent thereto, respectively. For example, the upper and lower surfaces of the aerogel layer 110 shown in FIG. 1 may be disposed to face the cells 200 formed on the left and right sides in FIG. 4, respectively. As another example, the upper surface of the aerogel layer 110 and the lower surface of the substrate 120 shown in FIG. 2 may be disposed to face the cells 200 formed on the left and right sides in FIG. 4, respectively. As a further example, the lower surface of the first substrate 130 and the upper surface of the second substrate 140 shown in FIG. 3 may be disposed to face the cells 200 formed on the left and right sides in FIG. 4, respectively. When the battery insulation sheet 100, according to embodiments, is formed between the plurality of cells 200, a battery module capable of substantially blocking flames or heat from one cell from advancing to another cell is provided, thereby suitably inhibiting the propagation of the heat and flames to the other cell with a higher level of safety, and a battery pack including the same.

Hereinafter, specific examples will be described. However, the following examples are intended to illustrate or describe aspects and features of the present disclosure and should not be construed as limiting the present disclosure. Contents that are not described herein may be sufficiently technically inferred by those skilled in the art, and therefore a description thereof will be omitted.

### Manufacture of Battery Insulation Sheet

### Example 1

### 1. Manufacture of Raw Material Mixture

A raw material mixture was manufactured by mixing powdered polytetrafluoroethylene as a dry binder and aerogel particles (D50 50 μm). The raw material mixture was subjected to primary dry mixing at a stirring speed of 1000 rpm at 25° C. for 10 min to manufacture a first mixture. Subsequently, the first mixture was further mixed at a stirring speed of 5000 rpm at 25° C. for 20 min to manufacture a second mixture.

The content of polytetrafluoroethylene was 50 wt % of the total amount of the raw material mixture, and the content of the aerogel particles was 50 wt % of the total amount of the raw material mixture.

### 2. Manufacture of Aerogel Layer

The prepared second mixture was introduced into an extruder and extruded at a temperature of 45° C. and a pressure of 50 MPa to form an aerogel layer having the aerogel particles distributed in a fibrillized polytetrafluoroethylene matrix. The thickness of the aerogel layer was measured to be 2 mm.

### 3. Manufacture of Battery Insulation Sheet

A battery insulation sheet was manufactured by laminating a 0.1 mm thick mica sheet (e.g., from Famica, Muscovite) on each of upper and lower surfaces of the aerogel layer by using a coating method using an adhesive.

### Example 2

A battery insulation sheet was manufactured by using the same method as in Example 1 except that a raw material mixture was manufactured to include 20 wt % of polytetrafluoroethylene and 80 wt % of aerogel particles.

### Example 3

A battery insulation sheet was manufactured by using the same method as in Example 1 except that a raw material mixture was manufactured to include 35 wt % of polytetrafluoroethylene and 65 wt % of aerogel particles.

### Example 4

A battery insulation sheet was manufactured using the same method as in Example 1 except that a raw material mixture was manufactured to include 65 wt % of polytetrafluoroethylene and 35 wt % of aerogel particles.

### Example 5

A battery insulation sheet was manufactured using the same method as in Example 1 except that aerogel particles having an average particle size D50 of 5 μm were used and a raw material mixture was manufactured to include 80 wt % of polytetrafluoroethylene and 20 wt % of the aerogel particles.

### Example 6

A battery insulation sheet was manufactured using the same method as in Example 1 except that aerogel particles having an average particle size D50 of 100 μm were used.

### Comparative Example 1

### 1. Manufacture of Aerogel Composition

An aerogel composition was manufactured by introducing polyvinyl alcohol (e.g., from Sigma Aldrich), as an aqueous binder, polytetrafluoroethylene, as a dry binder, and aerogel particles into an ultrapure solvent and mixing the same.

The solid content of the aerogel composition was measured to be 85 wt % of aerogel, 10 wt % of polyvinyl alcohol, and 5 wt % of polytetrafluoroethylene.

### 2. Manufacture of Battery Insulation Sheet

A slurry application of the manufactured aerogel composition was made to a 0.1 mm thick mica sheet (e.g., from Famica, Muscovite), another 0.1 mm thick mica sheet was laminated thereon in a sandwich manner, and coating was performed by using a roll-rolling method. Subsequently, an aerogel layer was formed by drying to manufacture a battery insulation sheet.

### Comparative Example 2

A battery insulation sheet was manufactured using the same method as in Comparative Example 1 except that an aerogel composition including 50 wt % of aerogel and 50 wt % of polytetrafluoroethylene as solid content was manufactured by adjusting the input amounts of raw materials. In this case, the battery insulation sheet could not be manufactured due to the difficulty in dispersing the polytetrafluoroethylene.

### Comparative Example 3

A battery insulation sheet was manufactured using the same method as in Comparative Example 1 except that an aerogel composition including 85 wt % of aerogel, 5 wt % of polyvinyl alcohol, and 10 wt % of polytetrafluoroethylene as solid content was manufactured by adjusting the input amounts of raw materials. In this case, the battery insulation sheet could not be manufactured due to the difficulty in dispersing the polytetrafluoroethylene.

### Experimental Example

### Experimental Example 1: Evaluation of Thermal Insulation

Thermal insulation of each of the battery insulation sheets manufactured in Examples 1 to 6 and Comparative Examples 1 to 3 was evaluated using the following method, and the results are shown in Table 1 below.

Measurement of thermal conductivity (mW/mK) at room temperature (23±5° C.) for performed by cutting each insulation sheet into 125 mm to 150 mm wide and 125 mm to 150 mm long samples, and the thermal conductivity of the sample was measured at room temperature (23±5° C.) by using HFM 436 Lambda equipment from NETZSCH. The lower the thermal conductivity at room temperature, the better the thermal insulation of the insulation sheet.

### Experimental Example 2: Evaluation of Dustiness

Dustiness of each of the battery insulation sheets manufactured in Examples 1 to 6 and Comparative Examples 1 to 3 was evaluated using the following method, and the results are shown in Table 1 below.

Dustiness test was performed by measuring weight reduction rate of each battery insulation sheet under vibration at 24 Hz/3 mm for 6 hours by using a vibration tester (ASTMC592-04)
Sample preparation including preparing a 12-inch×12-inch insulation sheet.
Weight reduction rate [%]=[(Weight of insulation sheet before evaluation)-(Weight of insulation sheet after evaluation)]/(Weight of insulation sheet before evaluation)×100

### Experimental Example 3: Evaluation of Flexibility

Flexural modulus of each of the battery insulation sheets manufactured in Examples 1 to 6 and Comparative Examples 1 to 3 was evaluated using the following method, and the results are shown in Table 1 below.

Flexural modulus (MPa) was measured by manufacturing a sample according to ASTM D790 from each insulation sheet, and flexural modulus of the sample was measured by using UTM (UT-005E) from MTDI. A 3-point bending analysis method was used. The manufactured sample was put on a support, force was applied to the center of the sample at a speed of 1 mm/min to 10 mm/min to record load, and an initial slope value was measured by dividing the load by 15% strain to measure the flexural modulus at 15% strain. The lower the flexural modulus, the more flexible the insulation sheet.

TABLE 1

| | | Thermal | Weight | Flexural |
|---|---|---|---|---|
| | | conductivity | reduction | modulus |
| | Coatability | [mW/mK @ RT] | rate [%] | [MPa] |
| Example 1 | ◯ | 18.3 | 0.00 | 0.060 |
| Example 2 | ◯ | 17.8 | 0.02 | 0.071 |
| Example 3 | ◯ | 18.1 | 0.01 | 0.082 |
| Example 4 | ◯ | 19.0 | 0.00 | 0.088 |
| Example 5 | ◯ | 19.5 | 0.00 | 0.090 |
| Example 6 | ◯ | 16.9 | 0.02 | 0.068 |
| Comparative | ◯ | 17.8 | 0.40 | 0.120 |
| Example 1 | | | | |
| Comparative | X | — | — | — |
| Example 2 | | | | |
| Comparative | X | — | — | — |
| Example 3 | | | | |

Referring to Table 1 above, the Examples exhibit excellent thermal insulation, dustiness, and flexibility. It can be expected that a high content of a binder having excellent heat resistance is included, and such Examples exhibit excellent heat resistance.

Referring to Examples 1 to 6, thermal insulation, dustiness, and flexibility vary depending on the content of aerogel particles and polytetrafluoroethylene. It can be seen that, when the average particle size of the aerogel particles is in a range of 50 μm to 100 μm and the content of polytetrafluoroethylene is in a range of 20 wt % to 65 wt %, better physical property measurement result.

Referring to Comparative Example 1, it can be seen that, when the aerogel layer is formed through a wet process by using a solvent, thermal insulation is similar to thermal insulation of Example 2 despite a higher content of aerogel particles, and flexibility and dustiness are also reduced. When the aerogel layer is manufactured through the wet process, as can be seen from Comparative Examples 1 to 3, it is not possible to include up to 5 wt % of polytetrafluoroethylene, and when the content of polytetrafluoroethylene exceeds the above value, it is difficult to form an aerogel layer due to a dispersibility problem. It can be seen that, when the aerogel layer is manufactured through the wet process, it is difficult to manufacture a battery insulation sheet having a small thickness, unlike the Examples.

Therefore, it can be seen that, when an aerogel composition according to embodiments is used, thermal insulation, heat resistance, flexibility, and low dust properties are excellent.

As is apparent from the above description, a battery insulation sheet according to embodiments may include a fibrillized polymer matrix in which aerogel is distributed through a dry process by using a heat-resistant dry binder and aerogel providing excellent thermal insulation, heat resistance, low dust properties, and flexibility of the battery insulation sheet.

While the foregoing describes embodiments of the present disclosure, the present disclosure is not limited thereto, and it is contemplated that various modifications may be made within the scope of the claims and their equivalents, the detailed description of embodiments, and the accompanying drawings, which also fall within the scope of the disclosure.

What is claimed is:

1. A battery insulation sheet comprising an aerogel layer, the aerogel layer comprising:
a fibrillized polymer matrix comprising a dry binder; and
aerogel particles distributed in the fibrillized polymer matrix.

2. The battery insulation sheet as claimed in claim 1, wherein the dry binder comprises a fluorinated binder, wherein the fluorinated binder is at least one selected from a group consisting of polytetrafluoroethylene, a polyvinylidene fluoride-hexapropylene copolymer, or polyvinylidene fluoride.

3. The battery insulation sheet as claimed in claim 1, wherein
the fibrillated polymer matrix accounts for 10 wt % to 90 wt % of a total amount of the aerogel layer, and
wherein the aerogel particles account for 10 wt % to 90 wt % of the total amount of the aerogel layer.

4. The battery insulation sheet as claimed in claim 1, wherein the aerogel particles have a BET specific surface area in a range of 500 m²/g to 1,000 m²/g.

5. The battery insulation sheet as claimed in claim 1, wherein the aerogel particles have an average particle size (D50) in a range of 5 μm to 100 μm.

6. The battery insulation sheet as claimed in claim 1, wherein the aerogel particles are dispersed inside the fibrillized polymer matrix.

7. The battery insulation sheet as claimed in claim 1, wherein the aerogel layer satisfies Formula 1 below:
$$0.1 \leq {W}_{FB} / {T}_{PM} \leq 18 \qquad [ Formula 1 ]$$
wherein W_{FB} is the content (in wt %) of the dry binder to the total amount of the aerogel layer, and T_{PM} is the average particle size (in μm) of the aerogel particles.

8. The battery insulation sheet as claimed in claim 1, further comprising a substrate on an upper surface, a lower surface, or upper and lower surfaces of the aerogel layer.

9. The battery insulation sheet as claimed in claim 8, wherein the battery insulation sheet has a structure in which a first substrate, the aerogel layer, and a second substrate are sequentially laminated.

10. A method of manufacturing a battery insulation sheet, the method comprising:
manufacturing a raw material mixture comprising a powdered dry binder and powdered aerogel particles; and
extruding the raw material mixture by using an extruder to manufacture an aerogel layer,
wherein the aerogel layer comprises a fibrillized polymer matrix comprising the dry binder in which aerogel particles are distributed.

11. The method as claimed in claim 10, wherein the manufacturing of the raw material mixture comprises a primary dry mixing step or primary and secondary dry mixing steps.

12. The method as claimed in claim 10, wherein the manufacturing of the raw material mixture comprises a primary dry mixing step and a secondary dry mixing step, and
wherein a stirring speed in the secondary dry mixing step is at least 2 times a stirring speed in the primary dry mixing step.

13. The method as claimed in claim 12, wherein, In the primary dry mixing step, a temperature is in a range of 20° C. to 65° C., a stirring speed is 2000 rpm or less, and a stirring time is in a range of 5 min to 15 min, and
wherein, in the secondary dry mixing step, a temperature is in a range of 20° C. to 65° C., a stirring speed is in a range of 4000 rpm to 10,000 rpm, and a stirring time is in a range of 10 min to 60 min.

14. The method as claimed in claim 10, wherein the manufacturing of the aerogel layer comprises introducing the raw material mixture into the extruder and extruding the raw material mixture in a sheet form.

15. The method as claimed in claim 10, wherein the manufacturing of the aerogel layer is performed at a temperature in a range of 25° C. to 150° C. and a pressure in a range of 1 MPa to 100 MPa.

16. The method as claimed in claim 10, further comprising laminating a substrate on an upper surface, a lower surface, or upper and lower surfaces of the aerogel layer.

17. The method as claimed in claim 10, wherein a first substrate and a second substrate are laminated on upper and lower surfaces of the aerogel layer, respectively.

18. A battery module comprising:
a plurality of cells; and
the battery insulation sheet as claimed in claim 1 between the plurality of cells,
wherein upper and lower surfaces of the battery insulation sheet respectively face adjacent ones of the cells.
